(19) United States
(12) Patent Application Publication
(10) Pub. No.: US 2012/0025614 A1
(43) Pub. Date: Feb. 2, 2012

(54) Uninterruptible Power Supply Apparatus and Methods Using Reconfigurable Energy Storage Networks

(76) Inventors: Pasi Taimela, Wake Forest, NC (US); Robert William Johnson, JR., Raleigh, NC (US); Anthony Olivo, Raleigh, NC (US)

(21) Appl. No.: 12/845,011

(22) Filed: Jul. 28, 2010

(51) Int. Cl. H02J 9/06; H02J 1/10

(52) U.S. Cl. 307/65; 307/71

(57) ABSTRACT

A power supply system includes an inverter circuit, for example, an inverter circuit of an uninterruptible power supply (UPS), having an output configured to be coupled to a load and an input configured to be coupled to a power source and a storage network configuration circuit configured to vary interconnections of a plurality of energy storage units of the power source, for example, plural ultracapacitors, responsive to a control input. The network configuration circuit may be operative to detect a state of the power source, such as a voltage produced thereby, and to modify parallel and serial coupling of the energy storage units responsive to the detected state. In some embodiments, the network configuration circuit may be operative to increase and/or decrease a number of the power source units connected in series across the input of the inverter circuit responsive to the detected state.

### BACKGROUND

The inventive subject matter relates to power supply apparatus and methods and, more particularly, power supply apparatus and methods for use with energy storage devices.

High-capacity, high availability energy storage devices, such as ultracapacitors, are often used to store power in applications such as electrical vehicle propulsion, solar and wind power generation and uninterruptible power supply systems. For example, U.S. Pat. No. 7,642,755 to Bartilson describes ultracapacitor based energy storage systems for use in applications such as motor drives. U.S. Pat. No. 6,265,851 to Brien et al. describes a power supply for an electrical vehicle which uses an ultracapacitor as a primary source and a battery as a supplemental power source. U.S. Pat. No. 6,703,722 to Christensen describes a power system that uses ultracapacitors for energy storage in conjunction with fuel cells. U.S. Patent Application Publication No. 2006/0192433 to Fuglevand et al. describes an uninterruptible power supply (UPS) that uses a combination of an ultracapacitor and fuel cell to provide backup power when a primary power source is interrupted.

### SUMMARY OF THE INVENTIVE SUBJECT MATTER

In some embodiments of the inventive subject matter, an uninterruptible power supply (UPS) system includes a UPS circuit having an output configured to be coupled to a load and first and second inputs configured to be coupled to first and second power sources. The UPS circuit is configured to selectively transfer power to the load from the first and second power sources. The system further includes a network configuration circuit configured to vary interconnections of a plurality of energy storage units of the second power source responsive to a control input. The network configuration circuit may be operative to detect a state of the second power source and to modify parallel and serial coupling of the energy storage units responsive to the detected state. The energy storage units may include ultracapacitors.

In further embodiments, the UPS circuit includes a first UPS circuit and the system further includes a second UPS circuit having an output configured to be coupled to the load in parallel with the output of the first UPS circuit and first and second inputs configured to be coupled to the first power source and a third power source, respectively. The third power source may have a greater energy storage capacity than the second power source. For example, second power source may include a plurality of ultracapacitors and the third power source may include an electrochemical battery. The first UPS circuit and the second UPS circuit may be power conversion modules having a like circuit topology.

In additional embodiments, the UPS circuit includes a third input configured to be coupled to a third power source and the UPS circuit is configured to selectively transfer power to the load from the first, second and third power sources. For example, the second power source may include a plurality of ultracapacitors and the third power source may include an electrochemical battery.

Further embodiments of the inventive subject matter provide a power supply system including a inverter circuit including an output configured to be coupled to a load and an input configured to be coupled to a power source and a network configuration circuit configured to vary interconnections of a plurality of energy storage units of the power source responsive to a control input. The network configuration circuit may be operative to detect a state of the power source and to modify parallel and serial coupling of the energy storage units responsive to the detected state.

In some method embodiments, a power source including a plurality of interconnectable energy storage units is coupled to an input of a UPS circuit of a UPS system. Interconnections among the energy storage units are varied responsive to a control input. For example, parallel and serial coupling of the energy storage units may be varied responsive to a detected state of the power source.

### BRIEF DESCRIPTION OF THE DRAWINGS

FIG. 1 is a schematic diagram illustrating a power supply system according to some embodiments of the inventive subject matter.

FIG. 2 is a flowchart illustrating operations for using a reconfigurable network of energy storage units according to some embodiments of the inventive subject matter.

FIG. 3 is a schematic diagram illustrating an uninterruptible power supply (UPS) system according to some embodiments of the inventive subject matter.

FIG. 4 is a flowchart illustrating operations for using a reconfigurable network of capacitive energy storage units according to some embodiments of the inventive subject matter.

FIGS. 5 and 6 illustrate examples of voltage and current waveforms, respectively, for a power supply system using a reconfigurable network of capacitive energy storage units according to some embodiments of the inventive subject matter.

FIG. 7 is a schematic diagram illustrating a reconfigurable energy storage network according to some embodiments of the inventive subject matter.

FIGS. 8 and 9 are flowcharts illustrating operations for using the energy storage network of FIG. 7.

FIG. 10 is a schematic diagram illustrating a reconfigurable energy storage network according to further embodiments of the inventive subject matter.

FIGS. 11 and 12 are schematic diagrams illustrating UPS systems according to some embodiments of the inventive subject matter.

FIG. 13 is a flowchart illustrating exemplary operations of the UPS systems of FIGS. 11 and 12.

FIG. 14 is a schematic diagram illustrating a modular UPS system according to further embodiments of the inventive subject matter.

### DETAILED DESCRIPTION OF EMBODIMENTS

Specific embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As will be appreciated by one of skill in the art, the inventive subject matter may be embodied as systems, methods and computer program products. Some embodiments of the inventive subject matter may include hardware and/or combinations of hardware and software. Some embodiments of the inventive subject matter include circuitry configured to provide functions described herein. It will be appreciated that such circuitry may include analog circuits, digital circuits, and combinations of analog and digital circuits.

Embodiments of the inventive subject matter are described below with reference to block diagrams and/or operational (e.g., flowchart) illustrations of systems and methods according to various embodiments of the inventive subject matter. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. In some implementations, the functions/acts noted in the figures may occur out of the order noted in the block diagrams and/or operational illustrations. For example, two operations shown as occurring in succession may, in fact, be executed substantially concurrently or the operations may sometimes be executed in the reverse order, depending upon the functionality/acts involved.

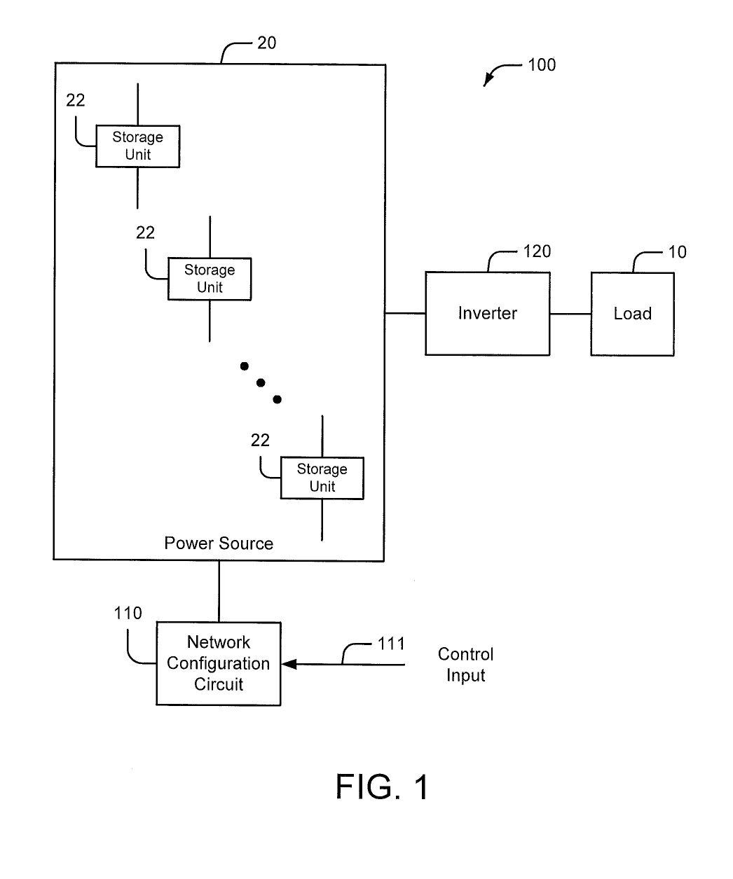

FIG. 1 illustrates a power supply system 100 according to some embodiments of the inventive subject matter. The system 100 includes an inverter circuit 120 having an output configured to be coupled to a load 10. The inverter circuit 120 has an input configured to be coupled to a power source 20 including a plurality of energy storage units 22. More particularly, interconnections of the energy storage units 22 of the power source 20 may be varied by an energy storage network configuration circuit 110 responsive to a control input 111, such as a measure of energy content of the power source 20. Other control inputs may include, for example, a current limit associated with a DC/DC converter circuit (not shown) coupling the power source 20 to the inverter circuit 120, instantaneous or other measures of power delivered to the load 10 by the inverter and the like.

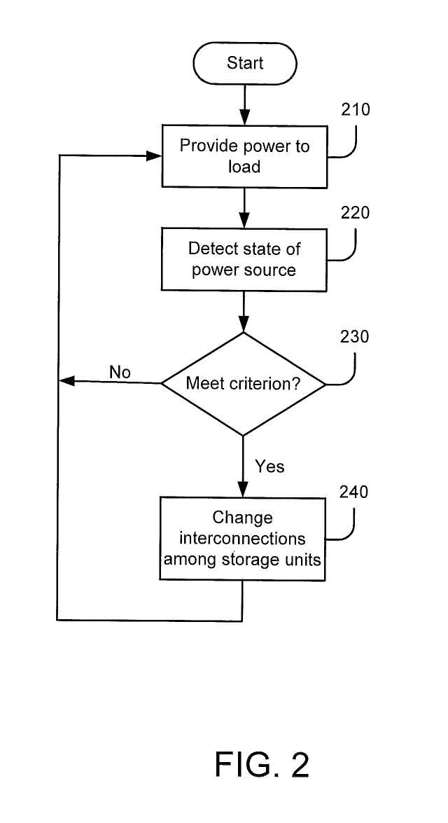

FIG. 2 illustrates exemplary operations of the power system 100 of FIG. 1. The power source 20, with the energy storage units 22 in a starting configuration, begins providing power to the load 10 via the inverter circuit 120 (block 210). A measure of a state (e.g., a voltage) of the power source 20 is generated (block 220). If the generated measure does not meet a criterion indicating a need for reconfiguration of the interconnections of the energy storage units 22, the power source 20 continues to provide power to the load 10 (blocks 230, 210). If the generated measure indicates a need for a reconfiguration, interconnections of the energy storage units 22 are changed, and the power source 20 continues to provide power to the load 20 (blocks 230, 240, 210).

The energy storage units 22 of FIG. 1 may include, for example, ultracapacitors, electrochemical cells and/or combinations thereof. In some embodiments described herein, the energy storage units 22 may include a plurality of ultracapacitors, and the energy storage network configuration circuit 110 may be configured to vary serial and parallel interconnections of the ultracapacitors responsive to, for example, a measure of voltage provided by the power source 20 (e.g., a measure of the total voltage provided by the power source 20 and/or a measure of a per-unit voltage of the constituent ultracapacitors). In further embodiments, such energy storage network configuration control may be advantageously used in uninterruptible power supply (UPS) systems to provide, for example, short term backup power in conjunction with a longer term backup power source, such as an electrochemical battery or fuel cell. In some embodiments, such energy storage network configuration control for a plurality of ultracapacitors may be flexibly used with standard UPS modules without requiring modification of the module components.

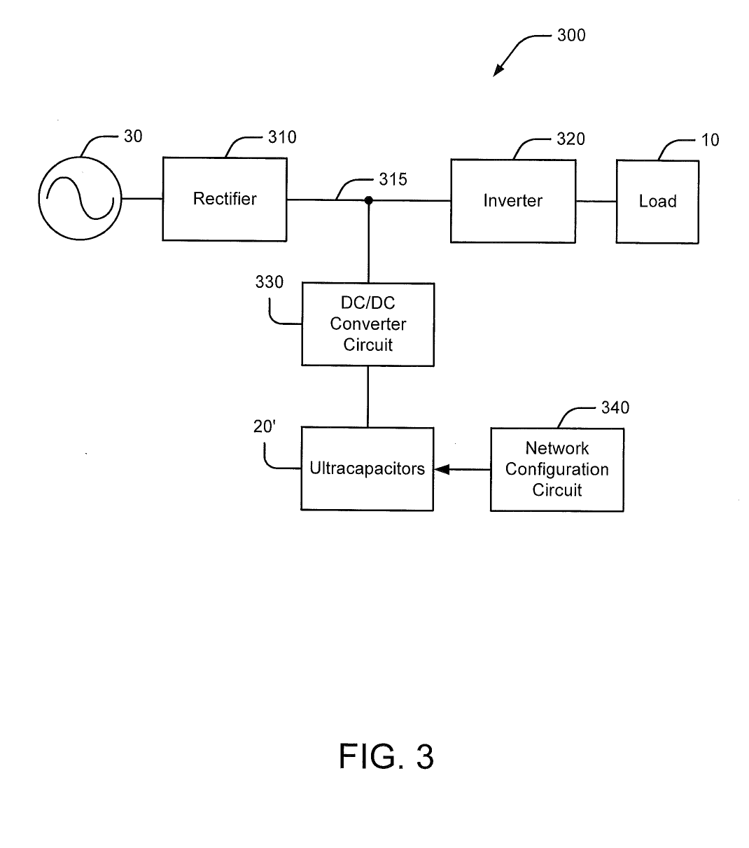

FIG. 3 illustrates an “on-line” UPS system 300 includes a rectifier circuit 310 and an inverter circuit 320 connected by a DC link 315. The rectifier circuit 310 is configured to receive AC power from an AC source 30, such as a utility line, and to generate a DC voltage on the DC link 315. The inverter circuit 320 is configured to generate an AC voltage for powering a load 10 from the DC link 315. A DC/DC converter circuit 330 is coupled to the DC link 315, and is configured to provide backup power from a backup power source, here shown as including a plurality of ultracapacitors 20′ having a network configuration that is controlled by an energy storage network configuration circuit 340. It will be appreciated that other types of UPS systems, such as “standby” and “line interactive” systems, may be similarly configured, i.e., a plurality of ultracapacitors may be used to supply power to an inverter thereof, with interconnections of the ultracapacitors being controlled by a energy storage network configuration circuit along the lines illustrated in FIG. 3. It will be further understood that the ultracapacitors 20′ may be charged in a number of different ways, such as by transferring current thereto from the DC/DC link 315.

Some embodiments of the inventive subject matter arise from a realization that some energy storage units, such as ultracapacitors, may offer substantial bursts of energy for use in applications such as backup power, but may have discharge voltage characteristics that are not particularly well-suited for use with UPS systems. Providing capability to modify the network interconnections of such storage units can enable the efficient use of such devices with conventional converters that may also be used, for example, to receive power from batteries and other energy storage devices that have different discharge characteristics.

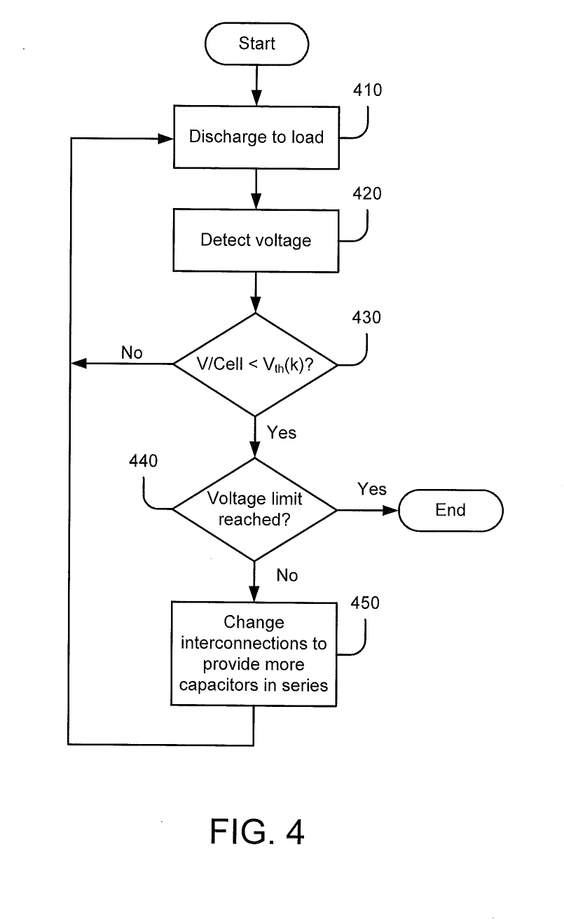

FIG. 4 illustrates an example of such operations in the UPS system 300 of FIG. 3 according to some embodiments of the inventive subject matter. After failure of the primary power source 30, the ultracapacitors 20′ begin discharging to the load 10 via the DC/DC converter circuit 330 and the inverter circuit 320 (block 410). A voltage of the ultracapacitors 20′, for example, a voltage applied to the DC/DC converter circuit 330 and/or voltages of individual ones of the ultracapacitors 20′ and/or groups of the ultracapacitors 20′, is detected (block 420). Based on the detected voltage, it may be determined whether a voltage per unit (e.g., per ultracapacitor) of the ultracapacitors 20′ is less than a threshold voltage Vₜₕ(k) (block 430). If the voltage per unit exceeds the threshold voltage Vₜₕ(k), the network configuration of the ultracapacitors 20′ remains unchanged and the ultracapacitors 20′ continue to discharge (block 410). If the voltage per unit falls below the threshold voltage Vₜₕ(k), however, and a voltage limit has not be reached, interconnections of the ultracapacitors are changed such that a greater number of the ultracapacitors 20′ are coupled in series across the input of the DC/DC converter circuit 330 to maintain a voltage applied thereto within a desired range (block 440), such that the ultracapacitors 20′ may continue to discharge to the load 10 (block 410). As the ultracapacitors 20′ continue to deliver energy to the load 10, the voltage is further monitored to determine if additional interconnection changes are needed to maintain the voltage applied to the DC/DC converter circuit 330 (blocks 420, 430, 440, 450). Once the voltage limit has been reached, however, the discharge may be terminated, as this may be indicative that most of the energy stored in the ultracapacitors 20′ has been depleted.

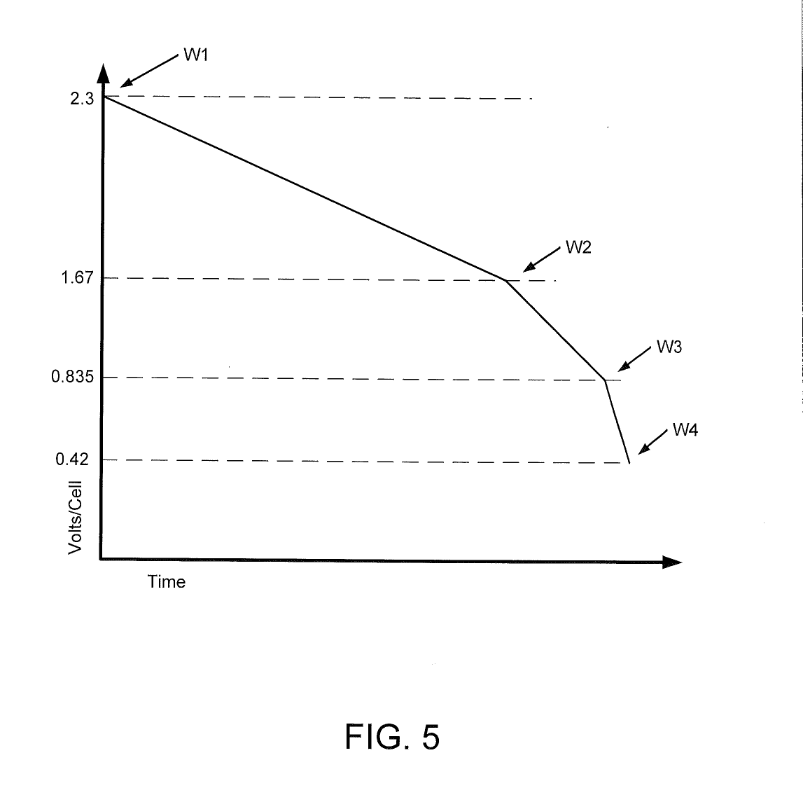

FIG. 5 theoretically illustrates operations along such lines using four strings of 280 series connected 5.5 Farad ultracapacitors having an equivalent series resistance of 0.3 ohms. Initially, the ultracapacitors are fully charged to 2.3 V/cell. Theoretically, assuming the four strings are initially connected in parallel when fully charged to an energy state W1, they provide an initial output voltage of approximately 640 V. As the ultracapacitors discharge, the output voltage declines. Eventually the cells reach approximately 1.67 volts per cell, corresponding to an output voltage of approximately 470V. At this point, the cells have reached an energy state W2 at which approximately 53% of the originally available energy remains:

$$\frac{W 2}{W 1} = \frac{1.67 {V}^{2}}{2.3 {V}^{2}} = 52.7 \% .$$

To boost the output voltage and limit the current delivered to the DC/DC converter, the interconnections of the ultracapacitors may be modified by joining pairs of the strings in series to provide two 560 cell strings coupled in parallel, which increases the output voltage to approximately 935 V. The ultracapacitors then further discharge, with the output voltage declining at a greater rate, causing the per cell voltage to drop to 0.835 V/cell at an energy state W3 at which the output voltage is again around 470 V. At this point, approximately 13% of the original energy remains:

$$\frac{W 3}{W 1} = \frac{0.835 {V}^{2}}{2.3 {V}^{2}} = 13.2 \% .$$

The four strings are then connected in series to boost the output voltage back to around 930 V.

After further discharge decreases the output voltage to the 470 V limit at an energy state W4, approximately 3% of the original energy remains in the ultracapacitors:

$$\frac{W 4}{W 1} = \frac{0.42 {V}^{2}}{2.3 {V}^{2}} = 3.3 \% .$$

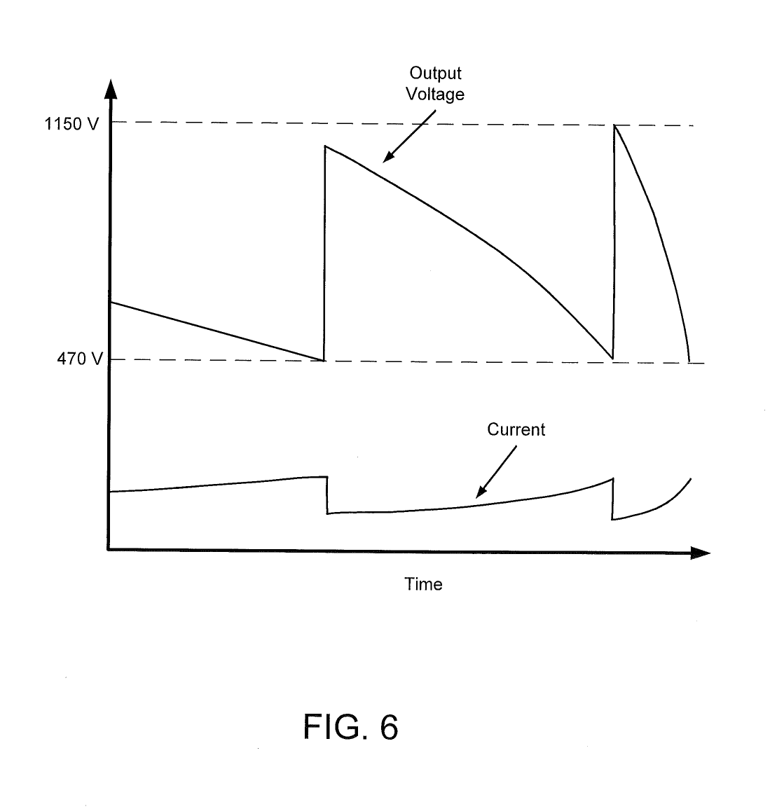

This theoretical calculation indicates that a vast majority of the original energy may be extracted in the first two steps (W1>W3). Simulation using non-ideal models indicates that the first step (W1>W2) leaves approximately 66% of the initial energy remaining in the ultracapacitor network and the second step (W2>W3) leaves approximately 20% of the initial energy, with the third step (W3>W4) extracting an additional approximately 13%, producing voltage and current as illustrated in FIG. 6.

From the above, it can be seen that using adaptive reconfiguration of the ultracapacitor network enables extraction of most of the energy stored in the ultracapacitors while maintaining voltage and current within bounds such that, for example, a DC/DC converter circuit of a UPS coupled to such a network may operate in a desirable voltage and current envelope. Thus, as explained in detail below, reconfigurable networks of ultracapacitors (or devices having similar discharge characteristics) can be advantageously used with modular UPS systems that are compatible with devices having significantly different discharge characteristics than ultracapacitors, such as lead-acid batteries. In this manner, the same hardware may be used with both types of energy storage devices.

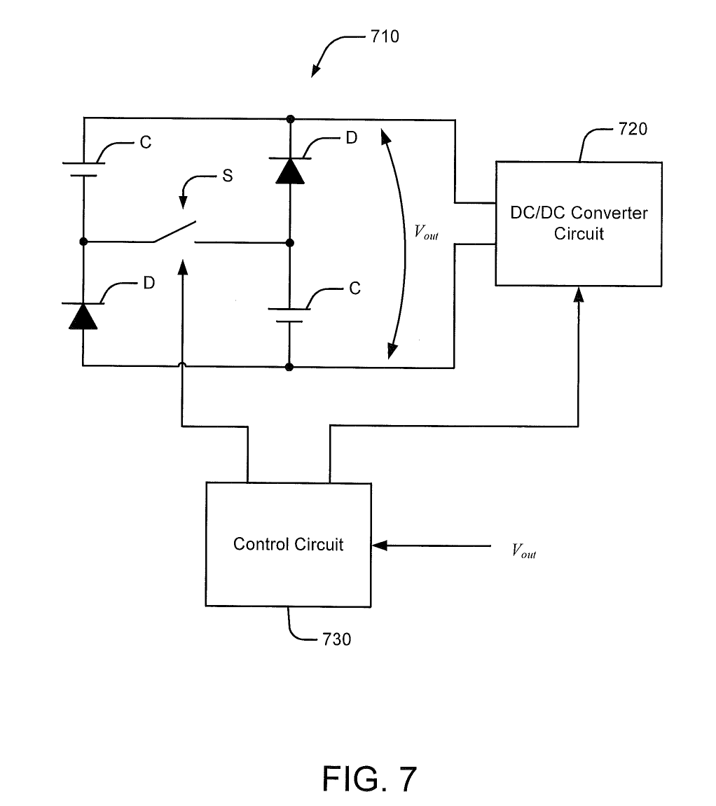

FIG. 7 illustrates a circuit supporting such adaptive reconfiguration according to some embodiments of the inventive subject matter. A power source 710 that includes first and second ultracapacitors C in first and second circuit legs along with diodes D. The ultracapacitors may be coupled and decoupled by a switch S. The power source 710 may be coupled to a DC/DC converter circuit 720, for example, a DC/DC converter of a UPS along the lines illustrated in FIG. 3.

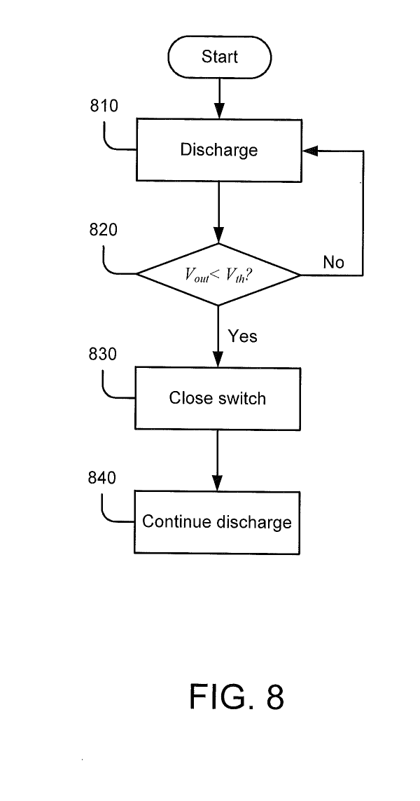

The switch S is controlled by a control circuit 730 responsive the output voltage Vₒᵤₜ, produced by the power source 710. When the switch S is open, the ultracapacitors C are connected in parallel, while closing the switch S couples the ultracapacitors C in series. Referring to FIG. 8, with the switch S open and the ultracapacitors C coupled in parallel, the power source 710 begins discharge to the DC/DC converter 720 (block 810). When the output voltage Vₒᵤₜ reaches a threshold voltage Vₜₕ, the control circuit 730 causes the switch S to close to couple the ultracapacitors C in series and thus raise the output voltage Vₒᵤₜ back above the threshold voltage Vₜₕ (blocks 820, 830). The ultracapacitors C may continue to discharge thereafter (block 840).

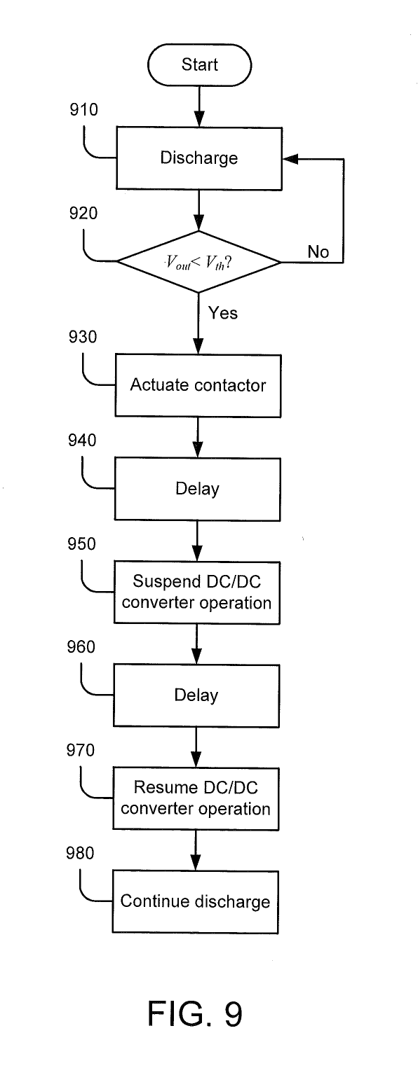

As shown in FIG. 7, the control circuit 730 may also control the DC/DC converter circuit 720 in cooperation with the switch S. For example, if the switch S is a contactor or similar electromechanical switch, it may be desirable to momentarily suspend operation of the DC/DC converter circuit 720 when the switch S closes to allow the output voltage Vₒᵤₜ to stabilize after the contacts close. Referring to FIG. 9, with the switch S open and the DC/DC converter circuit 720 active, the ultracapacitors C, which are initially coupled in parallel, begin discharging via the DC/DC converter circuit 720 (block 910). When the output voltage Vₒᵤₜ drops below a threshold voltage Vₜₕ, the control circuit 730 actuates the contactor switch S (blocks 920, 930). Because of mechanical limitations on the switch S may impose a significant delay between the time the actuation signal is asserted and the contacts of the switch S actually close, the control circuit 730 may wait a predetermined time before suspending operation of the DC/DC converter circuit 720 (blocks 940, 950) at or near the time the contacts actually close. After another predetermined delay to allow transients to die out, the control circuit 730 may cause the DC/DC converter circuit 720 to resume operation, thus allowing the reconfigured power source 710 to continue discharging (blocks 960, 970, 980). In UPS applications in which the DC/DC converter circuit 720 is coupled to a DC link that provides power to an inverter, capacitance coupled to the DC link and voltage regulation capabilities of the inverter may reduce or prevent any impact on the critical load that might arise from the momentary suspension of operation of the DC/DC converter circuit 720.

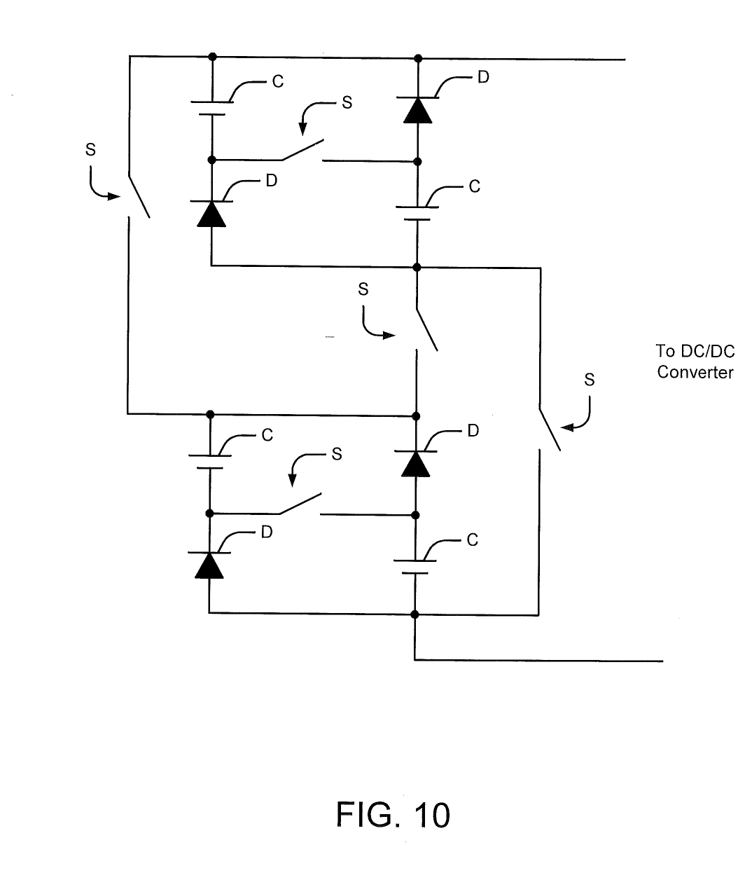

The power source 710 of FIG. 7 is offered for purposes of illustration, and it will be appreciated that other arrangements of ultracapacitors may be used to provide similar functionality. For example, the power source 710 illustrated in FIG. 7 provides two different configurations. In other embodiments, however, additional stages may be provided. For example, FIG. 10 illustrates a power source 1010 includes an arrangement of ultracapacitors C, diodes D and switches S that can support four different parallel/serial couplings by selective operation of the switches S. It will be further understood that devices other than ultracapacitors, such as lead-carbon cells, may be used in a similar fashion. In particular, circuits and operations as described above may be advantageously used with any of a variety of energy storage devices that produce output voltages that vary widely as they discharge.

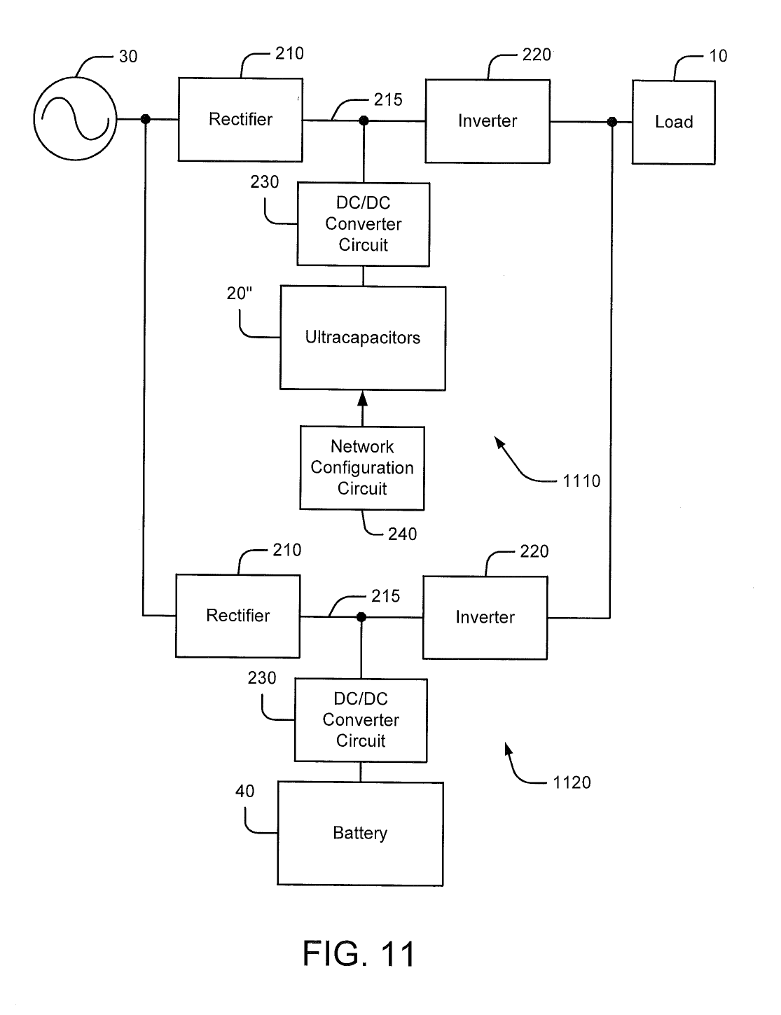

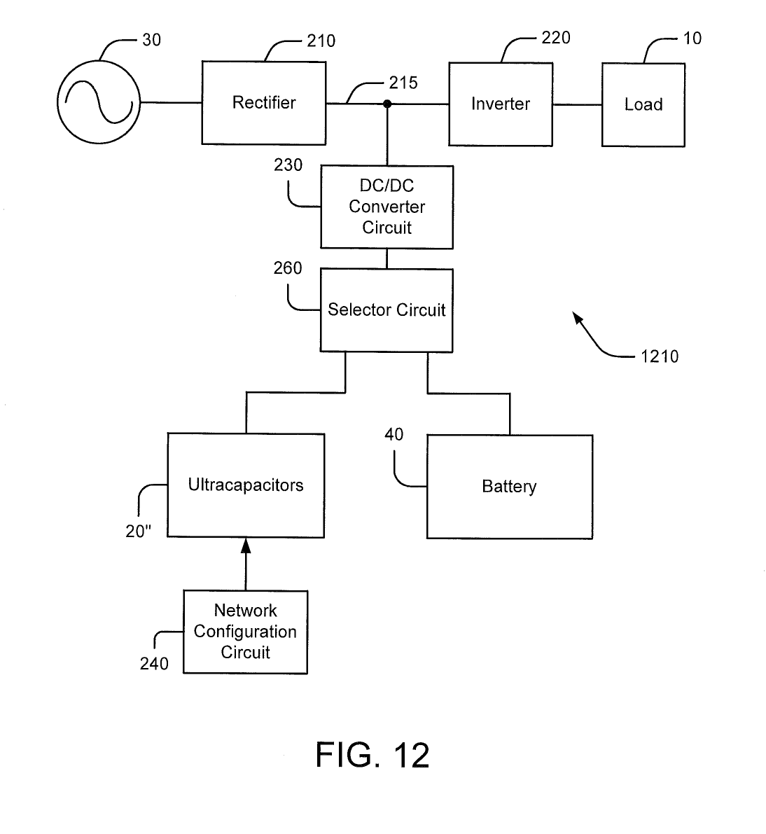

According to further embodiments, reconfigurable energy storage networks along the lines discussed above may be advantageously used in combination with other energy storage devices, such as batteries, in UPS applications. FIG. 11 illustrates a UPS system including first and second UPSs 1110, 1120 that are connected in parallel to an AC source 30 and a load 10. The first UPS 1110 includes a rectifier circuit 210 and an inverter circuit 220 coupled by a DC link 215. A DC/DC converter circuit 230 is also coupled to the DC link 215 and provides power thereto from a short term power source, for example, a plurality of ultracapacitors 20″, the interconnections of which are controlled by a network configuration circuit 240. The second UPS 1120 includes a similar rectifier circuit 210, inverter circuit 220, DC/DC converter circuit 230 and DC link 215. However, the DC/DC converter circuit 230 of the second UPS 1120 is coupled to a long term power source, such as an electrochemical battery 40. FIG. 12 illustrates an alternative configuration including a UPS 1210 including a rectifier circuit 210, inverter circuit 220, DC/DC converter circuit 230 and DC link 215 along the lines of the UPSs 1110, 1120 of FIG. 11, but with ultracapacitors 20″ with network configuration circuit 240 and an electrochemical battery 40 configured to be selectively coupled to the DC/DC converter circuit 230 by a selector circuit 260.

In either configuration, the ultracapacitors 20″ may be used to provide initial backup power in the event of the failure of the AC source 30, with the longer term battery 40 being brought on line if and when energy stored in the ultracapacitors 20″ is exhausted. Such an arrangement may be advantageous in many applications. In particular, in some applications, a large proportion of primary power source failures may be of short duration, such that the use of the ultracapacitors 20″ may reduce the duty on the battery 40. As ultracapacitors 20″ typically can withstand greater numbers of charge/discharge cycles in comparison to electrochemical batteries, this arrangement can offer improved reliability and service life in comparison to UPS systems that solely rely on batteries.

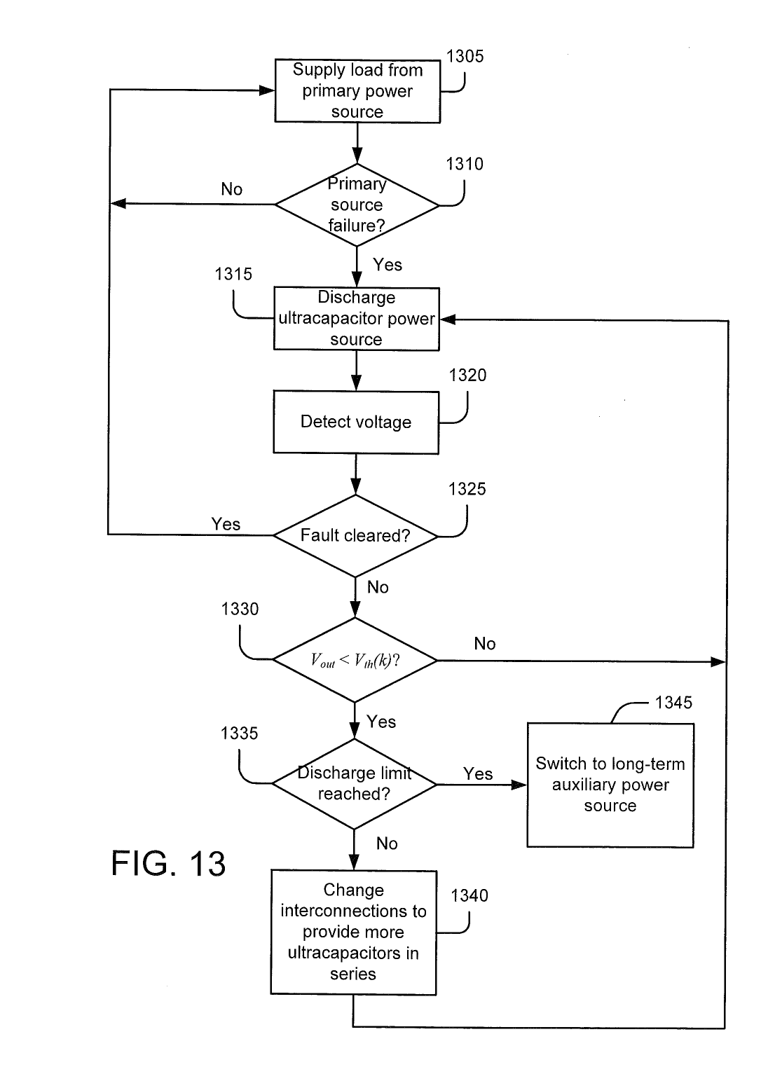

FIG. 13 illustrates exemplary operations for the circuits of FIGS. 11 and 12. The load 10 is powered from the primary source 30 (block 1305). Upon failure of the primary source 30, power is delivered to the load from the ultracapacitors 20″ (blocks 1310, 1315). As the ultracapacitors 20″ discharge, their output voltage is monitored (block 1320). If the primary source fault clears, the load is return to receiving power from the primary source (blocks 1325, 1305). If the fault has not cleared and the output voltage Vₒᵤₜ has yet to reach a threshold voltage Vₜₕ, the ultracapacitors 20″ continue to provide power to the load 10 (blocks 1330, 1315). If the output voltage Vₒᵤₜ from the ultracapacitors 20″ reaches the threshold voltage Vₜₕ and a discharge limit has not been reached, interconnections among the ultracapacitors 20″ are changed to increase the output voltage and continue provision of power to the load from the ultracapacitors 20″ (blocks 1330, 1335, 1340, 1315). If the discharge limit is met, however, the system transitions to providing power to the load from the battery 40 (block 1345).

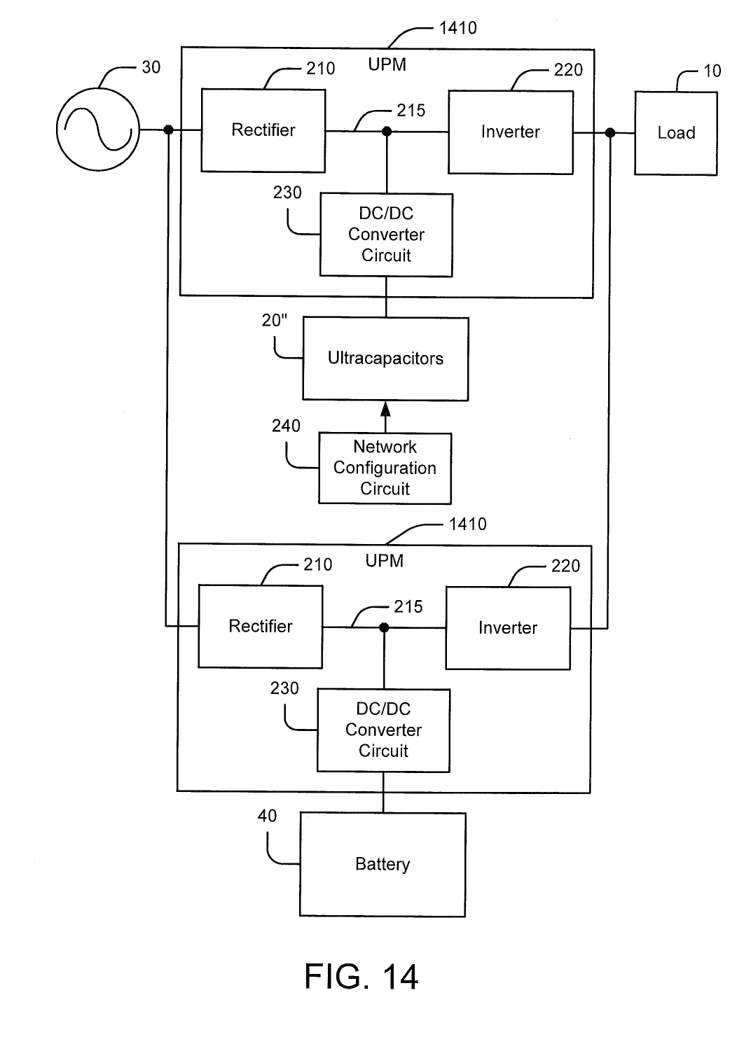

As noted above, using reconfigurable storage networks may also offer advantages in using modular hardware. FIG. 14 illustrates a UPS system in which paralleled like UPS modules (UPMs) are used with ultracapacitors 20″ and a battery 40. A network configuration circuit 240 associated with the ultracapacitors 20″ can control output voltage produced thereby such that the same DC/DC converter circuit 230 may be used for both the ultracapacitors 20″ and the battery 40. This can provide flexibility over a range of applications. In particular, in systems incorporating such UPMs can be selectively coupled to ultracapacitors or batteries depending on the size of the load, the duration of backup power expected to be needed and other considerations.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. An uninterruptible power supply (UPS) system comprising:
a UPS circuit having an output configured to be coupled to a load and first and second inputs configured to be coupled to first and second power sources, the UPS circuit configured to selectively transfer power to the load from the first and second power sources; and
a network configuration circuit configured to vary interconnections of a plurality of energy storage units of the second power source responsive to a control input.

2. The system of claim 1, wherein the network configuration circuit is operative to detect a state of the second power source and to modify parallel and serial coupling of the energy storage units responsive to the detected state.

3. The system of claim 1, wherein the control input comprises a voltage of the second power source.

4. The system of claim 1, wherein the energy storage units comprise ultracapacitors.

5. The system of claim 1, wherein the UPS circuit comprises an inverter having an input configured to be coupled to the second power source.

6. The system of claim 5, wherein the UPS circuit further comprises a DC/DC circuit having an input configured to be coupled to the second power source and an output coupled to the input of the inverter.

7. The system of claim 1, wherein the UPS circuit comprises a first UPS circuit and wherein the system further comprises a second UPS circuit having an output configured to be coupled to the load in parallel with the output of the first UPS circuit and first and second inputs configured to be coupled to the first power source and a third power source, respectively.

8. The system of claim 7, wherein the third power source has a greater energy storage capacity than the second power source.

9. The system of claim 8, wherein the second power source comprises a plurality of ultracapacitors and wherein the third power source comprises an electrochemical battery.

10. The system of claim 7, wherein the first UPS circuit and the second UPS circuit comprise like power conversion modules.

11. The system of claim 1, wherein the UPS circuit comprises a third input configured to be coupled to a third power source and wherein the UPS circuit is configured to selectively transfer power to the load from the first, second and third power sources.

12. The system of claim 11, wherein the second power source comprises a plurality of ultracapacitors and wherein the third power source comprises an electrochemical battery.

13. A power supply system comprising:
a inverter circuit comprising an output configured to be coupled to a load and an input configured to be coupled to a power source; and
a network configuration circuit configured to vary interconnections of a plurality of energy storage units of the power source responsive to a control input.

14. The system of claim 13, wherein the network configuration circuit is operative to detect a state of the power source and to modify parallel and serial coupling of the energy storage units responsive to the detected state.

15. The power supply of claim 13, wherein the energy storage units comprise capacitors.

16. A method of operating a UPS system, the method comprising:
coupling a power source comprising a plurality of interconnectable energy storage units to an input of a UPS circuit of the UPS system; and
varying interconnections among the energy storage units responsive to a control input.

17. The method of claim 16, further comprising detecting a state of the power source and wherein varying interconnections among the energy storage units responsive to a control input comprises modifying parallel and serial coupling of the energy storage units responsive to the detected state.

18. The method of claim 16, wherein coupling a power source comprising a plurality of interconnectable energy storage units to an input of a UPS circuit of the UPS system comprises coupling a first power source comprising a plurality of interconnectable energy storage units to an input of a first UPS circuit and wherein the method further comprises coupling a second power source to a second UPS circuit having an output coupled in parallel with an output of the first UPS circuit.

19. The method of claim 18, wherein the first power source comprises a plurality of ultracapacitors and wherein the second power source comprises an electrochemical battery.

20. The method of claim 16, wherein coupling a power source comprising a plurality of interconnectable energy storage units to an input of a UPS circuit of the UPS system comprises coupling a first power source comprising a plurality of interconnectable energy storage units to a first input of the UPS circuit and wherein the method further comprises coupling a second power source to a second input of the UPS circuit.

21. The method of claim 20, wherein the first power source comprises a plurality of ultracapacitors and wherein the second power source comprises an electrochemical battery.
